(19) United States
(12) Patent Application Publication
(10) Pub. No.: US 2003/0102637 A1
(43) Pub. Date: Jun. 5, 2003

(54) Adjustable anti-inundation sealing system

(76) Inventors: Willy Hamel, Liege (BE); Gaspard Moineau, Spa (BE)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/169,966

(22) PCT Filed: Jan. 12, 2001
(86) PCT No.: PCT/EP01/00343

(51) Int. Cl. F16J 15/02

(52) U.S. Cl. 277/630

(57) ABSTRACT

A sealing system which can be used to close to the opening of a dwelling or other building to prevent water, mud and other products from seeping into said dwelling. The inventive sealing system comprises a central panel consisting of two parts (10a, 10b) whereby said panel can be adapted to the dimensions of the opening that is to be protected; a peripheral inflatable air chamber (20) ensuring the tightness of said system; and a profiled frame (30) which is fixed to the periphery of the central panel (10) in order to guide and support the inflatable air chamber (20). The panel also comprises a central extension (50) which matches the shape of the profiled frame (30) and two parts (10a, 10b), which together form a lode wherein the two parts (10a, 10b) can be inserted, in addition to a guiding element (70) which serves as a support for the two parts (10a, 10b) and prevents the inflatable air chamber (20) from extending into the central part towards the inside of the lode.

### CROSS-REFERENCE TO RELATED APPLICATIONS

This application is the national phase of PCT/EP01/00343.

### STATEMENT REGARDING FEDERALLY SPONSORED RESEARCH OR DEVELOPMENT

Not Applicable.

### BACKGROUND OF THE INVENTION

The object of the present invention is a water protection system intended for use next to the access to a dwelling or other structure in order to prevent infiltration of water, mud and other substances into the protected dwelling.

More specifically, the invention relates to a leakproof panel designed to be mounded in front of a door or a window of a building in order to avoid water infiltration during floods.

The panel can also serve to prevent escape of water or other substances during a fire in a building or elsewhere.

Whether industrial buildings or domestic lodgings are involved, many types of services requiring sealing of building accesses, as well as devices for preventing leakage of water and mud into building interiors during floods and rising waters, which could cause considerable damage.

Essentially, for obvious reasons, it is desirable to be able to limit the propagation of water as much as possible across openings of buildings such as doors or windows. Two main techniques exist, of which the first can be used only for new construction since it consists specifically of constructing, from the very beginning of construction, walls equipped with external sealing devices. In order to do this, for example, a wall is constructed which consists externally of multiple layers using a watertight material. Its effectiveness is entirely relative and depends upon different factors. Furthermore, its price is rather high.

The second technique consists of barricading building openings with sand bags or with panels fixed to exterior walls and/or to door or window frames in order to resist elevated water pressure and to reduce infiltration of water, mud and other substances into buildings. If we consider damage caused by such floods despite use of these materials, it may be confirmed that this technique does not resist elevated water pressure and does not offer sufficient water tightness. These materials are also heavy and cumbersome. Difficulties in installation and transport also result from the use of such materials.

Document EP-A-0 848 136 describes a leak protection system designed to be used between the walls of an opening in a dwelling or other structure or other building in order to prevent leakage of water, mud or other substances into the dwelling to be protected. In particular, document EP-A 0 848 136 shows a leak prevention system which features a central panel which can be adapted to the dimensions of the opening to be protected; a peripheral inflatable air chamber which ensures the sealing qualities of the system; a formed frame attached to the peripheral of the central panel which is designed to support and guide the inflatable air chamber; and a central extension in the shape of a formed frame, and both parts form a gangue into which both parts are inserted.

Thus it is clear that a leak-prevention system is needed for use next to the external accesses of a building, a system which, in large measure, will allow the shortcomings noted in earlier systems to be addressed.

### BRIEF SUMMARY OF THE INVENTION

Consequently, one of the goals of the present invention is to provide a leakproof system which offers excellent qualities for resistance to elevated water pressure, while at the same time it is thinner and very easy to mount. Specifically, the object of the invention is to offer a leakproof panel that is low cost and which is of sufficient intrinsic resistance to water pressure.

Another goal of the present invention is to offer a leakproof system that can be adapted to any door or other opening to places requiring protection, without damaging door frames or the edges of adjoining walls.

These goals, as well as others, are achieved, according to the invention, by a new system of sealing designed to be used near an opening in a dwelling in order to prevent leakage of water, mud or other substances into the building requiring protection. The sealing system includes a central panel in two distinct parts adaptable to the dimensions of the opening to be protected, a peripheral inflatable air chamber which ensures watertightness of the system, a formed frame attached to the periphery of the central panel designed to support and guide the inflatable air chamber, and a central extension which adapts to the formed frame and of the two parts of the central panel and which form a gangue in which the two parts are inserted. More specifically, the system of the invention is characterized by the fact that it features, among other things, a guiding element which serves as a support for the two parts, and which prevents the inflatable air chamber from extending into the central portion towards the interior of the gangue.

The preferred methods of production for this invention are laid out in the related claims 2 through 23.

The system of the present invention offers excellent characteristics of watertightness and resistance to water pressure using the combination of a rigid panel and an inflatable air chamber, which serves not only for watertightness but also to maintain the panel in place under high pressure. These advantages are: reduced weight, a reduced thickness which, on the one hand, facilitates its transport to the place to be protected, and on the other hand, its rapid installation by simply inflating the air chamber, since this system comes preassembled.

The purpose of the panel is to prevent leakage of water and other substances into buildings and all places requiring protection. The panel, with its inflatable air chamber, adapts easily to different door dimensions or dimensions of other openings in places to be protected, without damaging door frames or other wall surfaces.

The panel can also serve as a barrier to the escape of water or other substances during a fire in a building or any other place.

The manufacturing technique specific to this sealing system invention allows it to be easily applied to an irregular support. It is never necessary to permanently affix the sealing system to the walls of the building being protected, which is very desirable after usage from an esthetic point of view. Continuity between the sealing system and the walls is ensured in order to obtain an overall rigid and watertight surface. Furthermore, it goes without saying that after deflating the air chamber, the sealing system is completely reusable.

Other characteristics and advantages of the present invention will become apparent during the description which follows and which is nevertheless given only for information purposes.

### BRIEF DESCRIPTION OF THE SEVERAL VIEWS OF THE DRAWINGS

The invention will be better understood upon reading the following description, which includes attached drawings, among which are:

FIG. 1, which shows a lateral schematic view of the different elements comprising the sealing system for building openings according to the present invention,

FIG. 2, which shows a lateral schematic view of the sealing system in FIG. 1 after assembly,

FIG. 3, which shows a cutaway schematic view of the profiled frame of the system in FIG. 1,

FIG. 4, which shows a cutaway schematic view of a variation of the air chamber of the system in FIG. 1,

FIGS. 5a, 55b and 5c, which are cutaway views of variations in plug closures,

FIG. 6, which shows a lateral schematic view of a variation in the sealing system according to document EP-A-0 848 136,

FIG. 7 which shows a lateral schematic view of the sealing system of the invention, and

FIGS. 8a through 8d show perspective views of the fully-assembled leakproof system in FIG. 7.

### DETAILED DESCRIPTION OF THE INVENTION

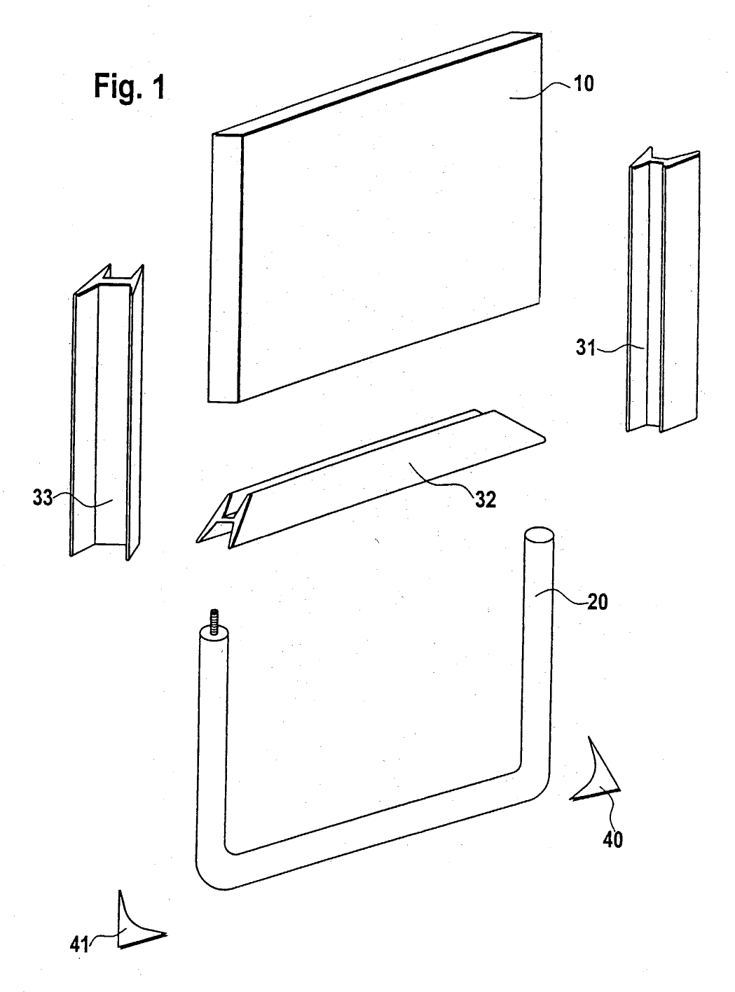

With regard to its composition, the sealing system in FIG. 1 includes a central panel 10 which is adaptable to the aperture of the building to be protected (e.g. a door or a window), a peripheral inflatable air chamber 20 which ensures the watertightness of the system, and a profiled frame 30 which is provided for adaptation to the periphery of the central panel 10 so as to support and guide the inflatable air chamber 20 as it is being inflated.

The assembled panel is then placed between the edges of the exterior walls, as close to the door or window frame as possible. Advantageously, the assembled panel can be placed against the frame of the door or window, with the profiled frame 30 placed in contact with the frame. Use of intermediary shims can also be considered.

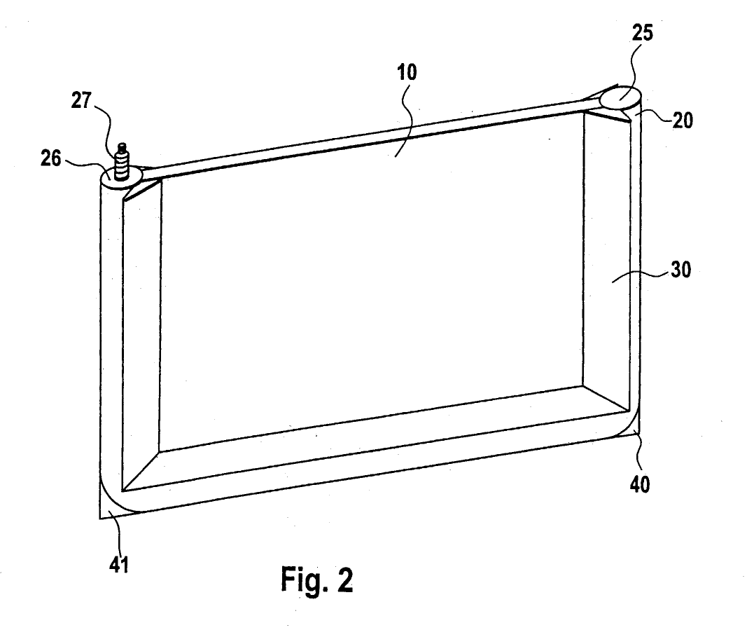

As seen in FIG. 2, assembly of the different elements allows us to obtain a separating partition that is relatively adjustable using the inflatable air chamber, which will fill the joints left between the panel and the two lateral edges of the walls. A space on the order of 1 to 3 centimeters on each side can be filled and made leakproof by inflating the air chamber in such a way that the same panel can be adapted to different openings.

The leakproof panel in the present invention offers, in particular, a capacity for resistance to high pressure, thanks to the presence of the inflated air chamber which holds the panel in place.

Regarding the material in panel 10, a choice can be made for a panel of marine wood or some other material, of any dimension, which is adaptable to the object being protected. For example, the sealing system can be supplied as a kit, with a panel 10 measuring 0.80 m high, 0.90 m wide and 18 mm thick. Other panels with different heights and/or widths can be provided upon request.

The profiled frame 30 serves as a support element and as a guide for the air chamber 20 around the central panel 10. Regarding frame 30, the material envisioned for its production is formed aluminum, or any other rigid material adapted to be affixed to the edges of central panel 10A rubber frame 30 can also be used. Each of elements 31, 32 and 33 can be formed in a single piece. The general shape of elements 31, 32 and 33 is an “H”, whose upper arms 34 and 35 are oriented towards the exterior of the device.

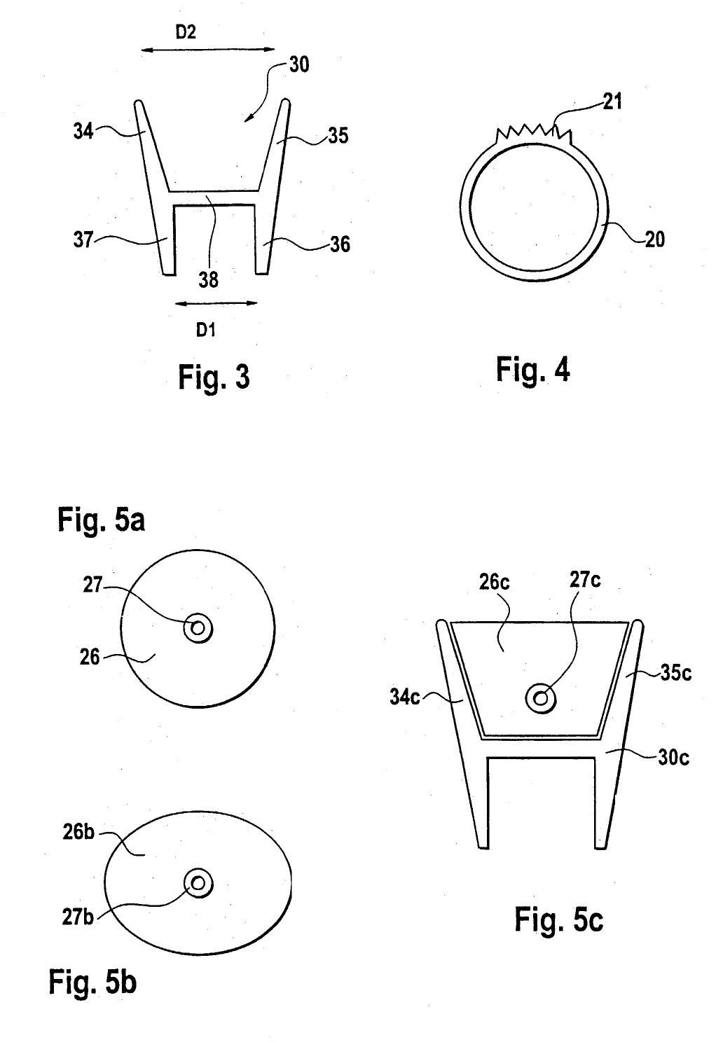

As FIG. 3 shows, formed frame 30 comprises two assembly elements 36 and 37 to which the central panel 10 can be affixed. The assembly is made using a spacer 38 shaped like a “U”, of the formed frame (30). This part 38 consists of two arms 36 and 37, which can be assembled on the peripheral edge of panel 10. The formed frame 30 can be affixed to the central panel 10 using glue and/or screws. A silicone joint can be used between the formed frame 30 and the central panel 10 in order to maintain its leakproof qualities. The interior distance D1 between arms 36 and 37 corresponds to the thickness of the central panel 10.

Guiding elements in the form of two arms 34, 35 serve to support the inflatable air chamber 20. Advantageously, arms 34 and 35 are directed towards the exterior relative to the plane of the central panel 10 in order to receive and guide the inflatable air chamber 20. For arms 34 and 35, a widening angle on the order of 20 degrees relative to the panel plane is envisioned for supporting the air chamber while allowing adequate inflation. The interior distance D2 between arms 34 and 35 corresponds approximately to the diameter of air chamber 20.

For air chamber 20, a choice can be made for a rubber air chamber or any other inflatable watertight material. As an example, we will use an air chamber made of 92C butyl rubber, 65°±50° shore, 1 mm thick and with an exterior diameter of 28 mm.

In the arrangement shown in FIG. 3, the formed frame 30 features three elements, 31, 32 and 33 respectively (FIG. 1), which are attached to the lateral and lower edges of the central panel 10 and, after assembly air chamber 20 has the general shape of a “U” which conforms to the formed frame 30.

The air chamber is a tube 20 of circular section and length corresponding approximately to the dimensions of the panel (height and length). The air chamber 20 can be glued to the formed frame 30. Alternatively, an air chamber with an oval cross-section can be utilized.

Advantageously, as shown in FIG. 4, air chamber 20 features a grooved surface 21, which comes into contact with the edges of the wall of the opening being protected. Whereas satisfactory results have been achieved with an air chamber with a smooth surface, the grooves 21 on the air chamber 20 allow this sealing system to achieve a greater resistance to elevated water pressure. Furthermore, the grooves 21 on the air chamber 20 make it more rigid and protect it from any significant deformation.

The air chamber 20 includes of a cylindrical plug 25, 26 in each of both ends, one of which 26 consists of an inflation ferrule 27 (FIG. 5a). As an example, a rubber plug 25, 26, 30-mm in diameter and 24 mm long can be used. In the case of an oval air chamber, as shown in FIG. 5b, corresponding oval plugs 26b are used (example: axis dimensions of 20 mm and 40 mm).

As is shown in FIG. 5c, trapezoidal plugs 26c in the shape of the formed frame 30c can be used. This manner of construction offers the advantage of having plugs 26c positioned entirely inside the formed frame 30c, plugs 26c being slightly withdrawn relative to arms 34c and 35c of frame 30c. Thus all damage to plug 30c and/or to the air chamber during installation can be avoided.

Advantageously, the air chamber will be lined with a strip of watertight foam rubber. This foam strip is intended to be used between the air chamber and the exterior wall edges of the building, in such a way as to equalize irregular surfaces of these walls, if necessary. As an example, this foam strip fills in the joints or any other irregularity in the building's exterior masonry. In this regard, a foam rubber strip 50 mm wide and 10 or 20 mm thick is envisioned.

Furthermore, corner-pieces 40 and 41 made of watertight foam are envisioned, destined to be used in the lower corners of the panel. These corner-pieces 40 and 41 ensure watertightness of the system between the angles formed by the lower corners of the opening being protected and the arc formed by the air chamber 20 in these areas.

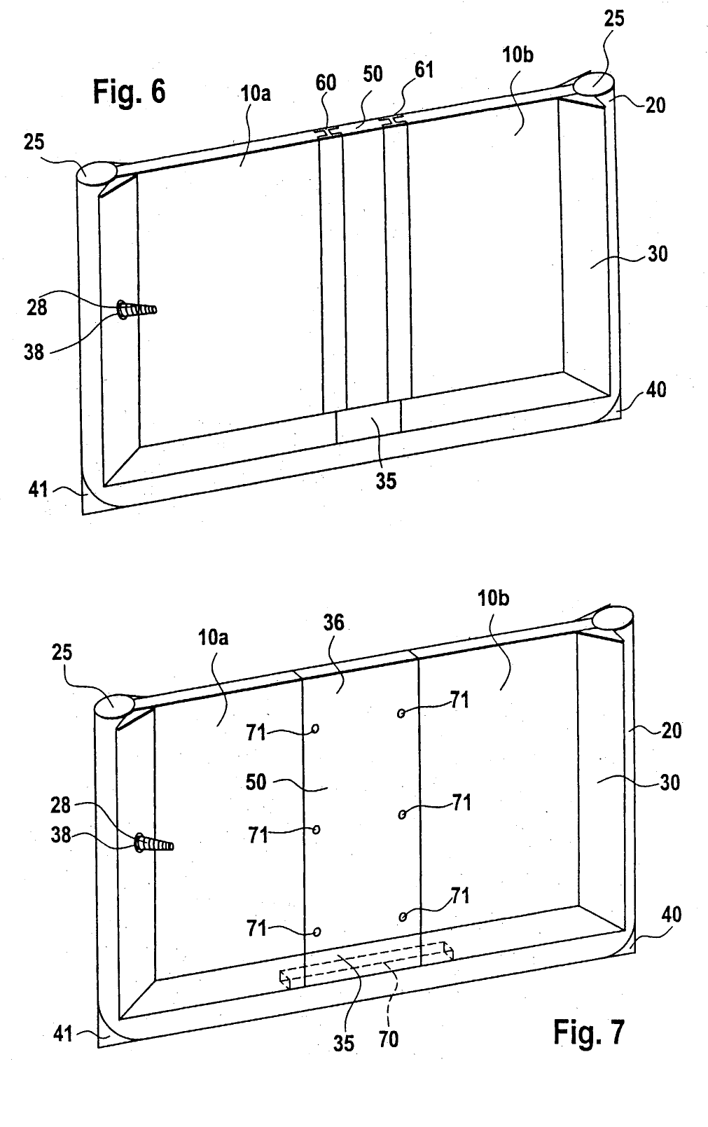

Following another arrangement described in document EP-A-0 848 136 illustrated in FIG. 6, the sealing system is comparable to the one in FIG. 2 but includes two central panels 10a and 10b, and an extension 40 whose purpose is to adapt it to openings of greater width. A means of attachment 60 is provided in order to link together the two parts 10a and 10b. Extension 50 of the panel can be inserted doc between the two parts 10a and 10b and attached to them using an additional method of fixation 61.

Advantageously, two fixation elements 60 and 61, with a profile in the shape of an “H”, are used to fix extension 50 to the central panels 10a and 10b. A frame extension 35, shaped in the same way as frame 30, is fixed to extension 50 in order to support and guide the air chamber 20 into place. Air chamber 20 is of sufficient flexibility to allow use of extension 50 and to enlarge the panel without a problem for the air chamber. As an example, this system can be supplied in kit form with extensions 50 of 5 cm, 10 cm and 15 cm such that openings of significantly different widths can be leakproofed or sealed. A space on the order of 1 to 3 cm between the sealing system and each side of the masonry edges is filled by inflating the air chamber. If extension 50 is not needed, the two panels 10a and 10b are affixed to each other using the one of the two shaped fixation elements 60 and 61.

In the arrangement shown in FIG. 6, air chamber 20 includes two closure plugs 25, 25 without an inflation ferrule. Air chamber 20 comprises a lateral inflation ferrule 28 and an opening 38 is introduced into the formed frame 30 in order to allow passage of an inflation ferrule 28. The same type of air chamber 20 with a lateral ferrule 28 can also be used in the version of the invention shown in FIG. 2.

In one specific version of the invention (not shown), three distinct air chambers corresponding respectively to the dimensions of the lateral and inferior edges of the central panel are used. These separate air chambers each feature two plugs at their ends, one of which features an inflation ferrule to allows the air chambers to be inflated independently of each other.

In another specific version the invention (not shown), the formed frame consists of four formed elements, adapted to be affixed to the four sides of the central panel. The system is thus customized for a complete closure of a window or a door. When constructed in this way, an air chamber of an overall circular shape can be used, and use of closing plugs is no longer necessary, since an inflation ferrule is affixed to the side of the air chamber.

In another specific version of the invention, shown in FIG. 7, the sealing system is comparable to the one in FIG. 6 but comprises two central panels 10a and 10b, and a variable extension 50, with a view to adapting it to openings of varying widths. A sliding guide 70 is provided to link the two parts of the panel 10a and 10b together. Panel extension 50 can be inserted between the two parts 10a and 10b and linked to them by several additional means of attachment 71, such as watertight bolts 71.

Advantageously, two extension elements 50 are affixed to the central panels 10a and 10b, using watertight bolts 71. The extension elements 50 include a lengthening of formed frame 35 in the same way as frame 30 to support and guide the air chamber 20 in this place. Air chamber 20 is of sufficient flexibility to permit use of the variable extension element 50 and to enlarge the panel without disturbing the air chamber.

When the air chamber 20 is constructed in this way, it features two closure plugs 25, 25 without an inflation ferrule. Air chamber 20 includes a lateral inflation ferrule 28 and an opening 38 is introduced into the formed frame 30 in order to allow passage of the inflatable ferrule 28. The same type of air chamber 20 with a lateral ferrule 28 can also be used in the manner described in FIG. 2.

Regarding the manner of construction shown in FIG. 7, the sealing system is adaptable to the width of any door or window thanks to one or two plates 50, of steel or any other metal or material offering similar solidity and watertightness. These plates are shaped like the form 30 and parts 10a and 10b of marine wood, which together take the shape of a gangue, in which are inserted the two half-panels of marine wood (or any other material which offers the same watertightness and resistance) to a depth that is variable to the millimeter as a function of the width of the door or window being protected. The space between the two half-panels 10a and 10b is filled below by a guiding ruler 70, which serves as a support to the two half panels 10a and 10b and prevents the pneumatic 20 from extending into the central portion towards the interior of the gangue. The two metallic plates 50 form a hollow gangue and are bolted to the half-panels 10a and 10b with watertight bolts 71.

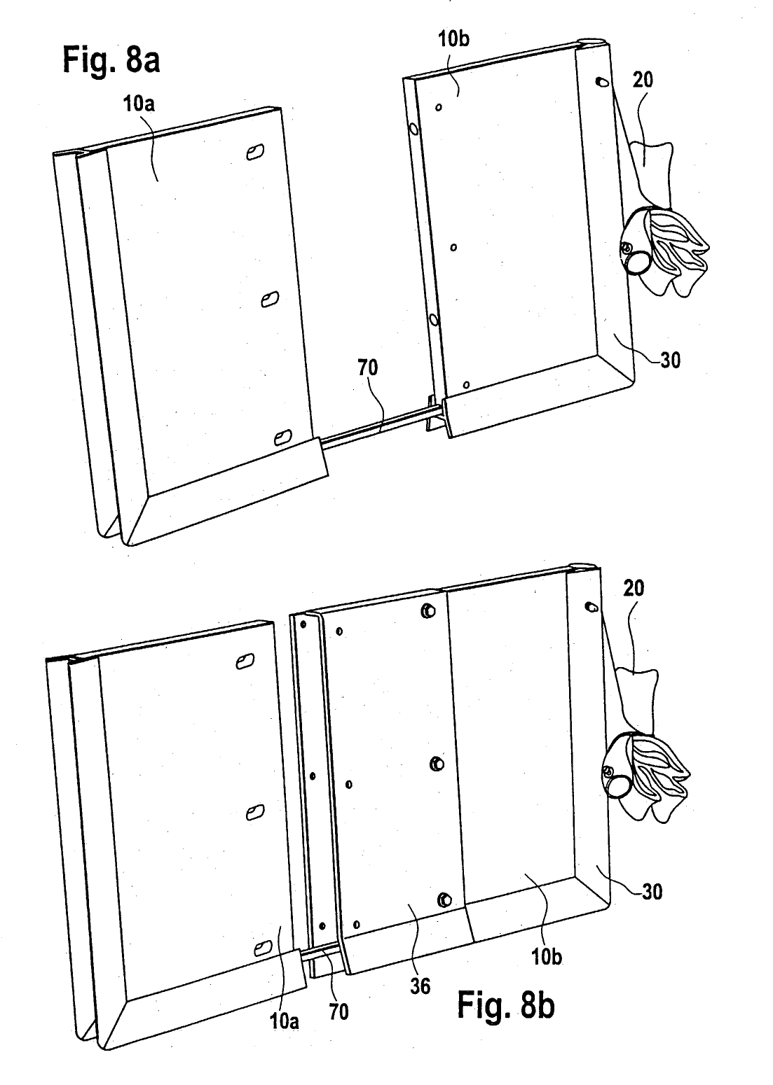

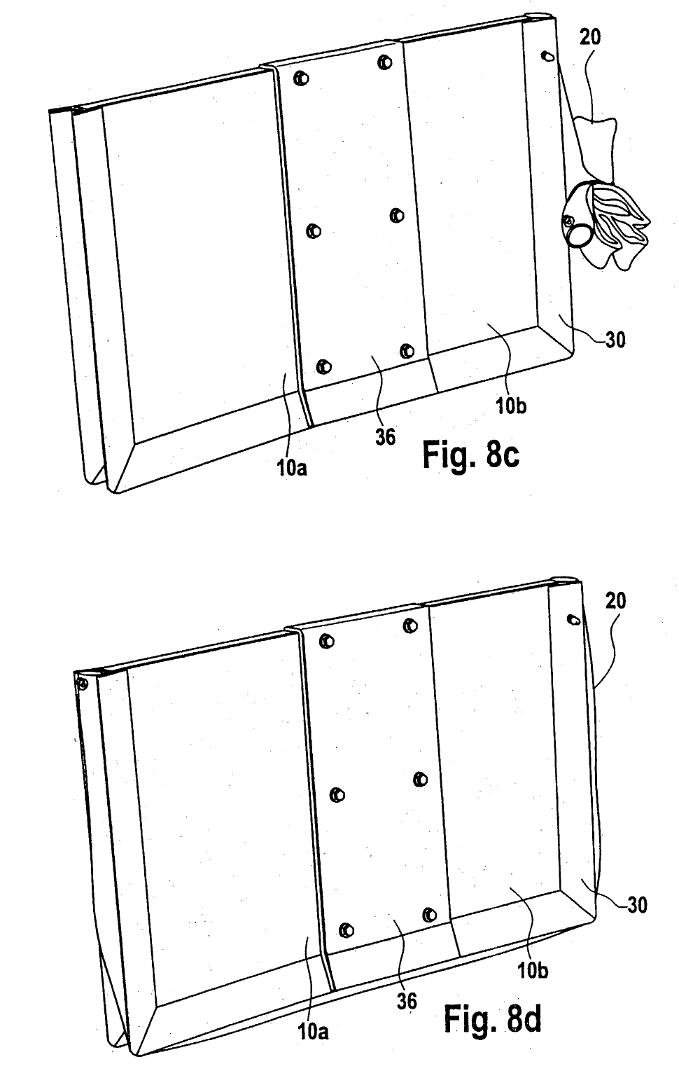

As shown in FIGS. 8a and 8d, this sealing system in its basic version is composed of two half-panels 10a and 10b of bakelited marine wood, inserted to a depth in proportion to the width of the door into a steel gangue 50 and belted on a semi-perimeter by an aluminum form 30 intended to guide and especially to protect an inflatable structure with an anti-skid surface, whose pressure on the walls ensures watertightness.

At least one of the two steel plates 50 includes an upper edge 36 that is bent at 90° so that it takes on the shape of the panels that also serve as stiffeners and to ensure rigidity. The two steel plates 50 may each include an upper edge, which oppose each other to ensure rigidity. The lengthening shape 35 of plates 50 in the lower portion takes on the shape of the form 30 and also serves as a stiffener.

The standard system can be adapted to all door widths between 80 and 100 centimeters and to a height of 80 centimeters, which is enough to handle 90% of floods in Europe. It can, of course, be custom-manufactured, which may become necessary, for example, in the case of a garage on an incline.

The initial mounting can be carried out at the client's home by a technician, because the system, although it is delivered in kit form, it must first be adapted to the width of the door.

In the kit, the aluminum shapes 30 are already affixed to the half-panels 10a and 10b, and the air chamber 20 is already attached to one of the half-panels.

The technician slides the sliding guide ruler 70 into the space provided for it to the height of the form 30 (FIG. 8a) and places the half-panels at about one centimeter from the wall partitions by sliding the guiding ruler 70.

He next places the two steel plates 50 on either side of the half-panel 10a that has not yet been perforated, and bores holes into plates 50 and panels 10a and 10b in the place defined by the width of the door in order to bolt it in place with the watertight bolts 71.

Once this operation has been completed, he next slides the second half-panel 10b into the steel gangue and attaches the bolts 71 into the holes drilled earlier. Adaptation to the width of the door is now complete. All that needs to be done now is the placement of air chamber 20. This air chamber is of sufficient elasticity that a difference of thirty centimeters presents no problem.

Once the air chamber 20 has been attached and screwed in its plug 25 to the other upper part of the form 30, the technician slightly inflates the air chamber 20 to adapt it to the desired size. After deflating it, he still needs to clip the foam or polystyrene corner 40 to the insides of the panels; he places the latter in front of the door, ideally against the rim, and again inflates the air chamber. The system is now ready to use. It can be deflated and put away with its accessories (spare corners, pump, back plates, silicone) near the door to save time in case of emergency.

In theory, the silicone should not be used unless the wall partitions show abnormal roughness, in which case they must be smoothed.

Thanks to this invention, even in the case of infiltrations through walls or basements, the rate at which the interior water level rises is slowed down so that it goes not higher than the flow capacity of a water pump. In the best case (new or leakproof walls and foundations, sealed air holes), the house is perfectly watertight.

The rate of increase of the water level in a residence is not only of prime importance as a function of the capacity for flow of the water pump. Even in the absence of a water pump, the tenant in these premises will appreciate the time saved thanks to the invention because it will allow him to save whatever he can.

Thus it is important, in case of emergency, to be able to rapidly install the system, and this is precisely one of its major attributes. If it is consistently stored near the door for which it was made, only a few seconds will be required to install it. It needs only to be put just in front of the door, and to proceed with inflation until the air chamber 20 causes pressure against the wall.

The system requires no prior installation to the walls or the doors that it protects against impacts and moisture, so that once all danger is passed, the residence immediately regains its normal appearance.

In another specific version of the invention (not shown), the bolts used to affix the half-panels to the gangue are useless, since the distance required between the two half panels in relation to the width of the opening to be protected, is ensured by springs or by a mechanical or electrical system that can be activated from outside by a crank or a button. These systems allow the panel to be adapted within a few seconds to the width of a door, and so they offer the Civil Protection Team, specifically, a time savings and easy access in case of emergency.

In another specific version of the invention (not shown), the sealing system also features, on the upper edges of the panels, two latches intended to serve as security against rising water pressure in case the walls and door- and window-frames serve as support points for the lateral portions of the gasket are particularly smooth and risk allowing the gasket to slip.

Once it is installed and inflated, the stability of the system is remarkable. Attempts to destabilize the device were unsuccessful. This stability is ensured by the pressure of the gasket against the lateral walls, despite the fact that the width of the system is variable. Additional water pressure only serves to increase this stability.

Nevertheless, the pressure of this same gasket on the floor would tend to lift the device if this pressure were greater than the lateral pressure. Over a certain width limit, the pressure on the floor would be greater than the lateral pressure, and water could seep in under the gasket.

This is why, in the case, for example, of a garage door, the use of two systems of this type is recommended, which would then be linked together by a central stanchion. In this other specific version of the invention (not shown), the device also features an aluminum cylinder, securely bolted to the floor and featuring on both sides of its diameter an extension in the shape of a widened “U”, similar in shape to frame 30 and designed to fit the air chamber. A metallic stem slides inside this cylinder. This stem is bolted to the ceiling to complete the stability of the system like a stanchion. The lateral extensions of the cylinder allow it to receive the respective gaskets of the two adjacent devices in the central part of the garage door. The system allows garage doorways of all dimensions to be effectively protected. Three devices of this type can also be used in this way, and two stanchions or even more can be used without decreasing the effectiveness of the system.

The installation by a technician thus consists of a first installation of the system, and therefore the preparation of the floor and ceiling with the bolting of the stanchion. If the panel is correctly mounted, the door can be opened without damage in order to allow entry and exit from the house before the water falls.

Other ways to produce the present invention, which are within the realm of the Craftsman's abilities, can also be foreseen without going outside of the scope of the invention.

1. A sealing system intended for use near the opening of a dwelling or other structure to prevent infiltration of water, mud or other substances into the dwelling to be protected; the system comprising:
a central panel in two distinct parts, adaptable to the dimensions of the opening to be protected,
a peripheral inflatable air chamber which ensures watertightness of the system,
a formed frame attached to the periphery of the central panel and designed to support and guide the inflatable air chamber,
a central extension which adapts to the formed frame and of the two parts of the central chamber and which form a gangue in which the two parts of the central chamber are inserted,
a guiding element which serves to support the two parts of the central panel and prevents the inflatable air chamber from expanding into the central section towards the inside of the gangue.

2. The sealing system according to claim 1, wherein the central extension comprises two metal plates which form a hollow gangue and which are secured to the two sections of the central panel.

3. The sealing system according to claim 1, wherein the central extension comprises a metallic plate with an overall bend of 180° which forms a hollow gangue and which is fastened to the two sections of the central panel.

4. The sealing system according to claim 1, wherein the central extension forms a gangue and has at least one upper edge (36) folded to a 90-degree angle so that it takes the shape of two sections of the central panel and serves as a stiffener, and ensures the rigidity of the central portion.

5. The sealing system according to claim 1, wherein the shape of the lengthener of the central extension in the looser part takes the form of the frame and thus serves as a stiffener.

6. The sealing system according to claim 1, including springs fitted into the two parts of the central panel or a mechanical or electrical system which can be activated from outside the system by crank or button to separate the two parts of the central panel to the width required by the opening to be protected.

7. The sealing system according to claim 1, including two screws on the upper edges of two parts of the central panel to serve as safety devices against rising pressure in case the walls and wall frames, which serve as support points for the lateral portions of air chamber are particularly smooth and risk allowing the air chamber to slide.

8. The sealing system according to claim 1, including a telescoping stanchion which is adapted to be screwed to the ground and the ceiling to ensure central stability against rising pressure, and which allows the system to be connected to itself where openings are very large, by means of a double extended form, on both sides of the telescoping stanchion that is designed to receive the air chambers of the two systems in the center section.

9. The sealing system according to claim 1, wherein the formed frame includes arms to which the central panels is affixed, as well as a guide, in the shape of two arms, to support the inflatable air chamber.

10. The sealing system according to claim 9 wherein the arms of the guide are expanded towards the exterior relative to the plane of the central panel in order to receive and guide the inflatable air chamber.

11. The sealing system according to claim 1 wherein the frame includes a connecting portion to connect the frame to the panel; the connecting portion being in the shape of a “U” and comprising of two arms which can be joined to the peripheral edge of panel (10).

12. The sealing system according to claim 1, wherein the frame is made of two distinct pieces and is made of aluminum.

13. The sealing system according to claim 1, wherein the air chamber includes a grooved exterior surface.

14. The sealing system according to claim 1, wherein the fact that air chamber has a circular cross-section and includes a cylindrical plug at each of its two ends.

15. The sealing system according to claim 1, wherein air chamber has an oval cross-section and features a plug having an oval cross-section at each of its two ends.

16. The sealing system according to claim 1, wherein the air chamber includes a plug of trapezoidal cross-section at each of two ends, the plug begin adapted to be inserted into the formed frame (30).

17. The sealing system according to claim 1, wherein the air chamber includes a plug at its two ends, the plug having an inflation ferrule for the air chamber.

18. The sealing system according to claim 1, wherein the air chamber includes a plug at its two ends, the plug having a lateral inflation ferrule; the formed frame having a perforation through which the inflation ferrule extends.

19. The sealing system according to claim 1, including a watertight foam strip adapted to be used between the air chamber and the walls of the opening of the building, in such a way as to equalize any irregular surfaces of these walls.

20. The sealing system according to claim 1, including corner accessories of watertight foam which are adapted to be used in the lower corners of the device.

21. The sealing system according to claim 1, wherein the formed frame includes four elements affixed respectively to the lateral edges and to the lower edge of each part of the central panel; the air chamber having the general shape of a “U” which conforms to the shape of the formed frame.

22. The sealing system according to claim 1, wherein the air chamber comprises three distinct air chambers which correspond to the dimensions of the lateral and lower edges of the central panel; each one of these air chambers featuring a plug at each end.

23. The sealing system according to claim 1, wherein the formed frame features four elements which are adapted to be attached to the four sides of the central panel; wherein the air chamber is of generally circular shape, such that it allows complete closure of the opening to be protected.
